(19) United States
(12) Patent Application Publication
(10) Pub. No.: US 2007/0000739 A1
(43) Pub. Date: Jan. 4, 2007

(54) Brake system

(76) Inventor: Wade Lamarr, Everett, WA (US)

Correspondence Address: DAVID W. C. CHEN, P.O. BOX 3041, SEATTLE, WA, 98114-3041, US

(21) Appl. No.: 11/173,560

(22) Filed: Jul. 1, 2005

(51) Int. Cl. F16D 55/26

(52) U.S. Cl. 188/72.9; 188/72.6

(57) ABSTRACT

Brake systems, assemblies and methods for use on remote control vehicles. In some embodiments, a counter-link member is provided to cause an opposing torque on a brake cam as a function of turning a wheel of the remote control vehicle, which can decrease a force applied to brake discs of the vehicle. In other embodiments, a counter-link member is provided along with a counter-cam, wherein the counter-cam can be moved to release or re-establish force applied to brake discs as a function of turning a front wheel of the vehicle.

### BACKGROUND OF THE INVENTION

1. Field of the Invention

The present invention relates generally to brake systems for vehicles, and in particular, to brake systems for radio controlled (R/C) toy vehicles usable in competitive racing.

2. Description of Related Art

Remote control or radio-controlled (RIC) vehicles are a popular past time and hobby in the United States and abroad. Typically, these vehicles respond to wireless signals sent from handheld remote control units. The signals are received by a receiver on the vehicle which decodes the transmission and drives servos to actuate arms or levers. In that manner, a user can actuate, among other things, breaks, throttle and steering on the vehicle remotely.

Competitive events for R/C vehicles, such as competitive racing of R/C cars, continue to gain popularity. R/C hobbyists that participate in competitive events seek out performance features for their vehicles and new performance enhancing products continue to evolve. However, a long felt problem has been present with regard to braking systems for R/C cars and their performance when braking in turns.

For example, one-eighth (⅛^{th}) scale R/C cars are often used in competitive racing events. A large portion of work done by the brakes in these cars during braking is via the front brakes. Thus, if brakes are applied during turns, the cars tend to skid forward detracting from steering control. This problem is commonly realized among R/C car hobbyists.

### BRIEF SUMMARY OF THE INVENTION

In some embodiments of the present invention, a remote control vehicle has a steering servo and steering member, such as a steering lever, connected to the steering servo. An interlocking member can be connected to the steering lever. When the steering servo is actuated to steer the vehicle, the interlocking member can be moved. The interlocking member can be linked to a brake cam of a brake system of the vehicle, to apply an opposing torque to the brake cam to reduce or increase braking power as a function of steering movement. For example, in some embodiments of the present invention, when front wheels are turned, the braking power is reduced, and when they are straightened, braking power is re-established to an original baseline function of power for the brake system.

In other embodiments of the present invention, a counter-cam is provided that can be rotated to release pressure on brake pads of the remote control vehicle. The counter-cam can be provided in addition to a brake cam that is used to apply pressure to the brake pads when brakes are applied. Methods for reducing braking power are also provided, along with break system assemblies for implementing and applying various embodiments of the present invention.

### BRIEF DESCRIPTION OF SEVERAL VIEWS OF THE DRAWINGS

FIG. 1a is a perspective view of a center differential assembly and various brake system components usable in some embodiments of the present invention.

FIG. 1b is a perspective view of the embodiment of the invention shown in FIG. 1a, without showing the brace, gear casing or gear.

FIG. 2 is a simplified block diagram of radio controlled of some embodiments of the present invention.

FIG. 3a is on overhead plan view of an embodiment of a brake system for the present invention, without illustrating rear brake components.

FIG. 3b is the embodiment of FIG. 3a, but with the brake lever displaced in the direction of arrow “E.”

FIG. 3c is the embodiment of FIG. 3b, showing an orientation of an interlocking lever of the presenting invention prior to movement of a steering lever.

FIG. 3d is the embodiment of the FIG. 3c, after movement of the steering lever in the direction shown by arrow “G.”

FIG. 3e is the embodiment of the invention shown in FIG. 3c, after movement of the steering level in a direction opposite to that indicated by arrow “G.”

FIG. 4a shows an alternative embodiment of the present invention, without illustrating components connecting the cam link to the brake lever, and further depicting a counter-cam of the present invention.

FIG. 4b shows the embodiment of the invention in FIG. 4a, after turning the counter-cam.

### DETAILED DESCRIPTION OF THE INVENTION

In the following description, certain specific details are set forth in order to provide a thorough understanding of various embodiments of the invention. However, upon reviewing this disclosure one skilled in the art will understand that the invention may be practiced without many of these details. In other instances, well-known or widely available structures and systems associated with radio control components and mechanical components of radio controlled (R/C) vehicles are have not been described in detail to avoid unnecessarily obscuring the descriptions of the embodiments of the invention. Also, various embodiments of the present invention are described in the context of R/C cars. However, the applications of the present invention are contemplated for a variety of other contexts and the examples set forth herein are not intend to be limiting.

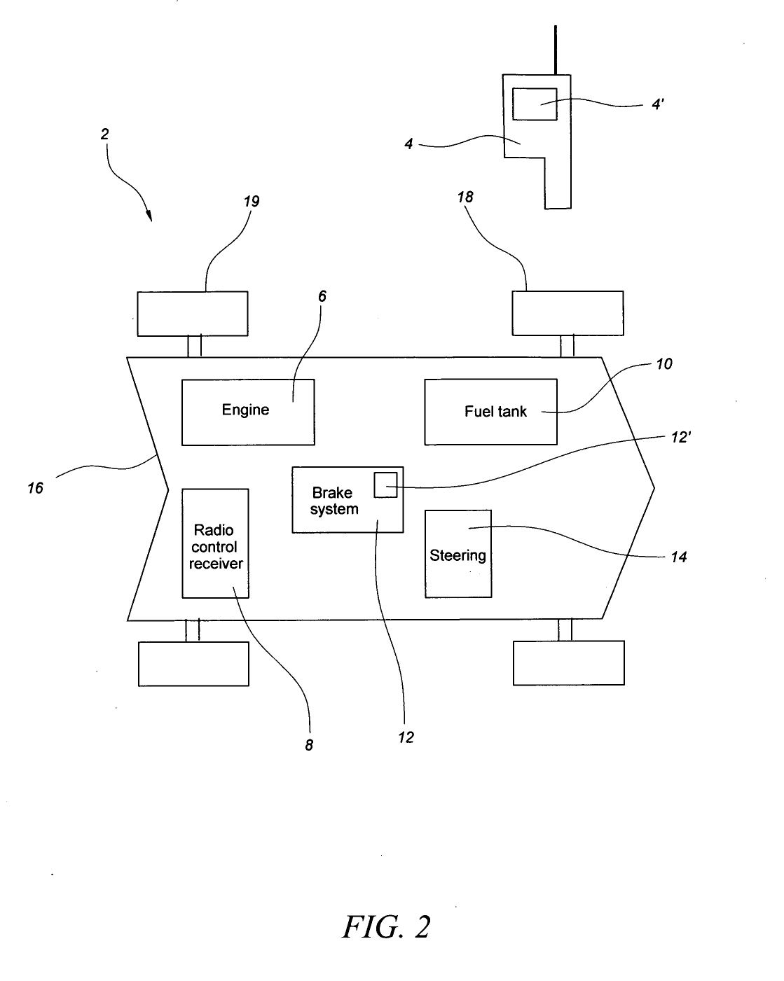

As best seen in FIG. 2, some embodiments of the present invention comprise a radio controlled (R/C) vehicle 2 and a remote control unit 4 (hereinafter “control unit”) with a transmitter 4′. The RC vehicle 2 can have a body 16, front wheels 18 and back wheels 19, and be fitted with, among other things, an engine 6, receiver 8, fuel tank 10, brake system 12 with brake servo 12′ (which can also serve as a throttling servo with opposite response) and steering system 14 having a steering servo (no depicted). The control unit 4 can be operated by a user to control the engine 6, brake system 12 and steering system 14 by sending signals to the receiver 8 from the transmitter 4′. The receiver 8 decodes the signals sent by the user to drive various servos for operating steering, braking and throttle of the vehicle 2.

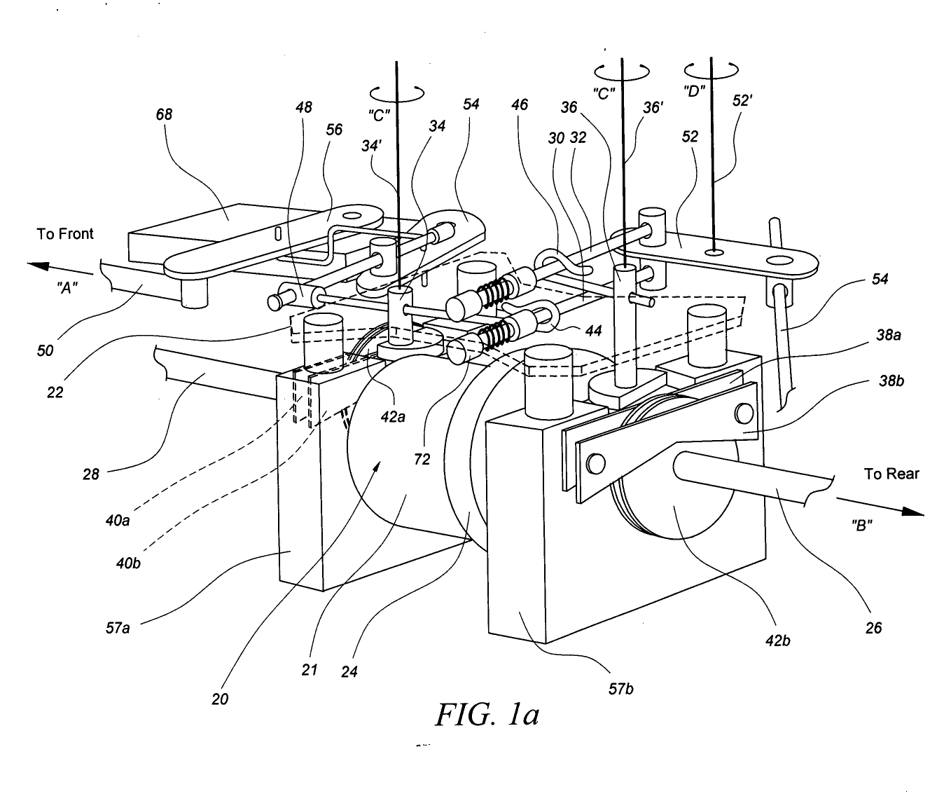

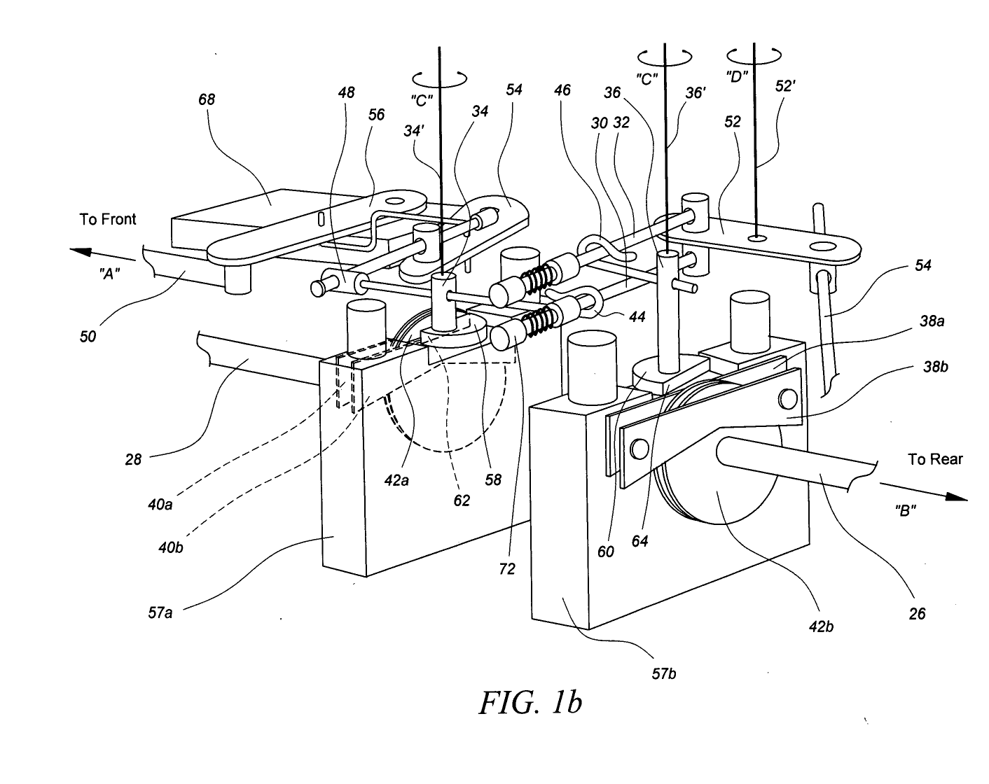

Referring to FIG. 1a, a combined assembly is shown including a center differential assembly 20 with a case 21 and a gear 24, drive shafts 26 & 28 and various brake system components 30, 32, 34, 36, 38a, 38b, 40a, 40b, 42a & 42b, 44, 46 which can be used in various embodiments of the present invention. Also, a steering shaft 50 and front drive shaft 28 are shown extending toward the front portion of the vehicle, as indicated by arrow “A”, whereas a rear portion drive shaft 26 extends toward a rear portion of the vehicle, as indicated by arrow “B.” As will be appreciated by those skilled in the art after reviewing the present disclosure, the center differential assembly 20 can be supported by brace 22, and the drive shafts 26 & 28 can be coupled to the center differential assembly 20.

Now referring to FIG. 1b (which illustrates some components of the combined assembly shown in FIG. 1a, but without showing the brace 22, casing 21 and gear 24), a brake lever 52 can be provided which can be pivoted when a brake servo (not shown) is actuated, causing the brake lever 52 to pivot about axis 52′ in the directions of arrow “D.” Primary lever links for the front and rear brake (front lever link 30 and rear lever link 32), which are rods in the illustrated embodiments, are pivotably connected to the brake lever 52. In turn, front cam-link 44 and rear cam-link 46 are also provided and coupled correspondingly to the front lever link 30 and rear level link 32. Break cams (front cam 34 and rear cam 36) are also provided and pivotably connected t o corresponding mounting members 57a & 57b, such that the cams 34, 36 can rotate or pivot about axes 34′, 36′ in the directions of arrows “C”. When the cams 34, 36 rotate about the axes 34′, 36′ in the directions of arrows “C”, cam heads 58 & 60 also rotate, causing corresponding contact faces 62, 64 on the cam heads 58, 60 to push against brake pads 40a and 38a. This can place tension on brake discs 42a & 42b, as will be appreciated by those skilled in the art after reviewing this disclosure. Thus, the front cam-link 44 and rear cam-link 46 are each connected to corresponding front brake cam 34 and rear brake cam 36 so that a user can apply brakes by actuating brake lever 52 using the control unit 4.

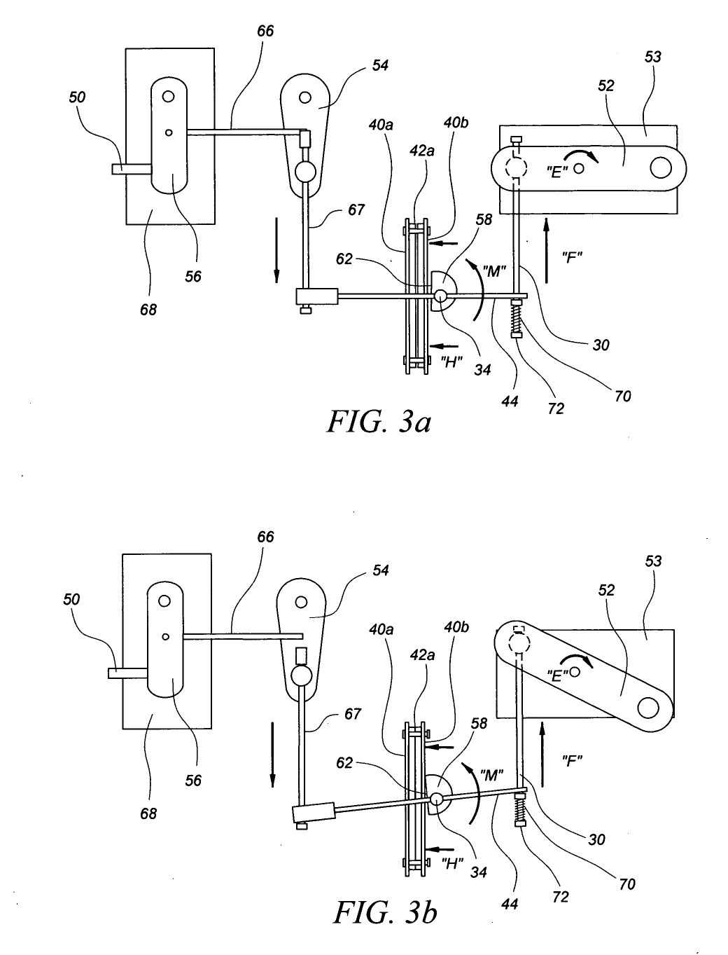

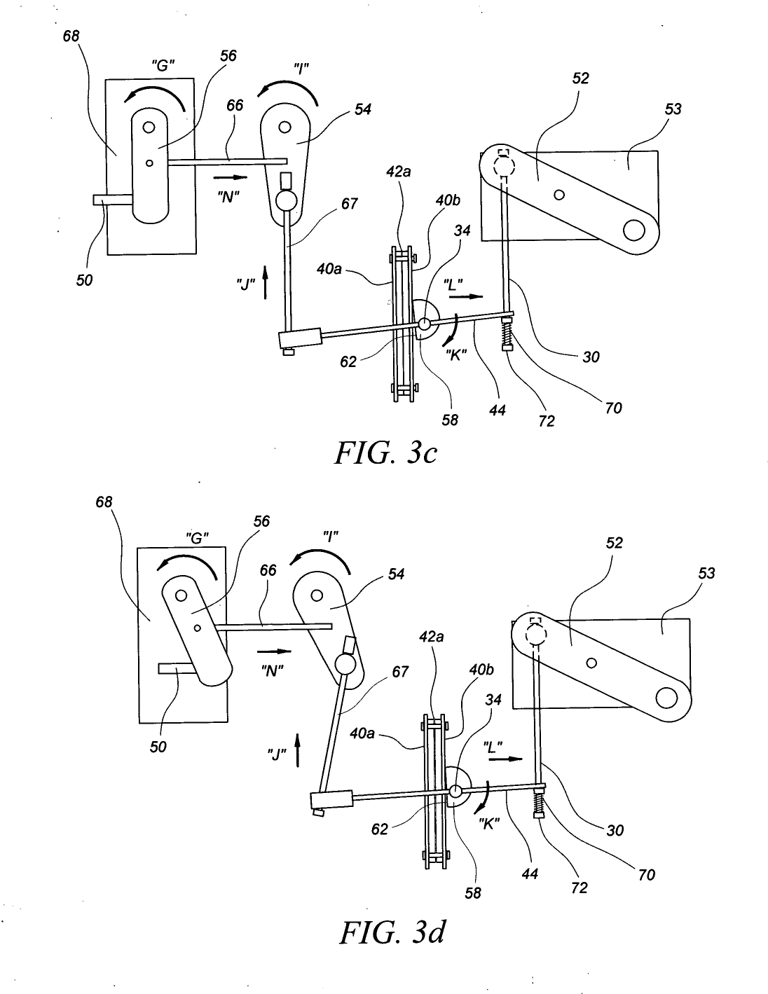

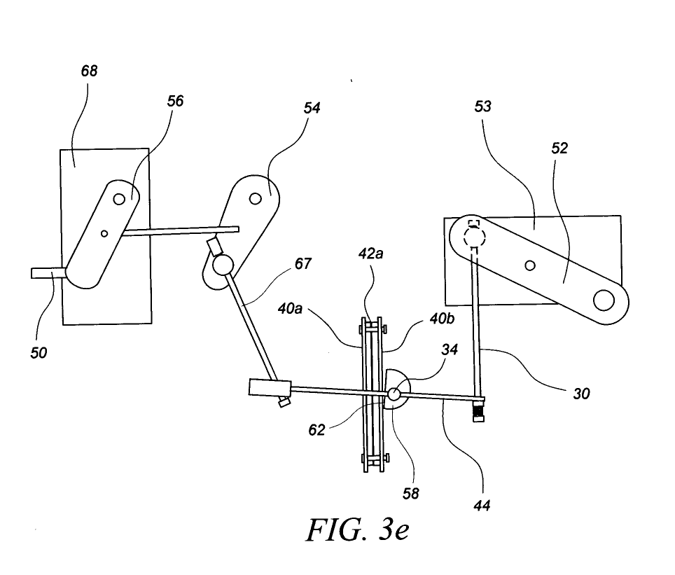

A more detailed description of the brake system 12 and its components as it applies to the front wheels 18, is now provided for some embodiments of the present invention. Referring to FIGS. 3a and 3b (which illustrate simplified overhead plan views of the some brake system components of FIG. 1b and their interaction), the brake lever 52 can be displaced in the direction of, for example, arrow “E,” by user actuation of the brake servo 53. When the brake lever 52 pivots in the direction of arrow “E,” the front link lever 30 is pulled in the direction of arrow “F.” This then applies torque on front cam 34 via the front cam-link 44, rotating the cam head 58 in direction “M” to drive a portion of the contact face 62 thereof into the brake pad 40b. The brake pad 40b is then pushed in the direction of arrow “H” applying pressure to break discs 42a (which can include one or more break discs proximate to one another). As will be appreciated by those skilled in the art after reviewing this disclosure, this can cause braking work to be applied through the front wheels.

After brakes have been applied to the front wheels, a user may turn the front wheels. FIG. 3c illustrates an embodiment of the present invention with the brakes applied to the front wheels 18 and before a user turns the front wheels 18, but with arrows “G” and “I,” showing directions of pivot of a steering lever 56 and interlocking lever 54 that are about to occur in connection with a front wheel turn in one direction. FIG. 3d illustrates the embodiment of FIG. 3c, after the turn occurs, as selectably controlled by a user. FIG. 3e shows the embodiment of FIG. 3d, but with the front wheels turned in an opposite direction. As can be seen in FIGS. 3c & 3d, the interlocking lever 54 can be linked to the front steering lever 56, by an interlocking link 66, such as a rod. The front steering lever 56 is used to turn the front wheels when actuated by steering servo 68, as will be appreciated by those skilled in the art after reviewing this disclosure. For example, the front steering lever 56 can be driven by the steering servo 68 to pivot in the direction of arrow “G”, thereby driving the steering shaft 50, to turn the front wheels 18. At the same time, the interlocking link 66 will be displaced in direction “N” by the steering lever 56, which causes the interlocking lever 54 to pivot in the direction of arrow “I,” as can be seen in FIGS. 3c & 3d. Also, a counter-link 67 is provided that has an end portion coupled to the interlocking lever 54 and an opposite end portion coupled to the front cam-link 44. It is noted that in this embodiment, the counter-link 67 is coupled to an end portion of the front cam-link 44 while an opposite the end portion of the front cam-link 44 is coupled to the front link lever 30, as described previously. In this manner, counter force can be applied to the front cam-link 44 (to counter force applied by front lever link 30 that causes front brakes to be applied) to release or decrease total force or pressure applied to the break discs 42a by the brake servo 53. The counter force applied can cause cam-head 58 to rotate in the direction of arrow “K” (opposite the direction of arrow “M”) as shown in FIGS. 3c & 3d, which turns a portion of the contact face 62 away from the brake pad 40b, with a directional component of arrow “L”, thereby causing pressure to be decreased on the brake discs 42a, or fully released. This can decrease braking work (and powered) delivered through the front brakes.

A buffer spring 70 can be retained on the front lever link 30 between a stationary stop 72 and an end portion of the front cam-link 44, as can be seen in FIGS. 1b, 3c and 3d. In some embodiments, the response of the buffer spring 70 can be selected to achieve various levels of response to the actuation of the brakes and to the counter force applied via the counter-link 67.

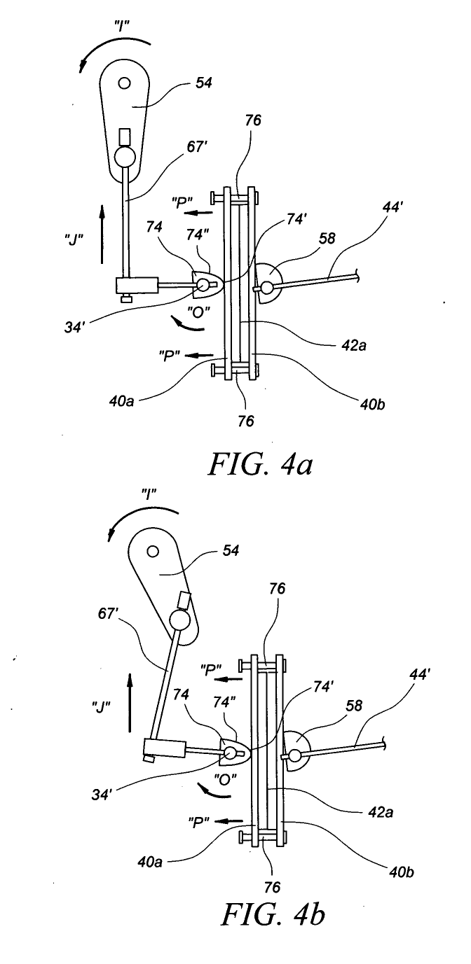

In another embodiment of the present invention, as illustrated in FIGS. 4a & 4b, a cam-link 44′ is provided to drive cam head 58 when the brake servo 53 is actuated. However, the cam-link 44′ is not connected to a counter-link 67. Instead, a counter-cam 34′ with a counter-cam head 74 is provided. The counter-cam head 74 can be pivotably 10 mounted on a mounting member (not depicted) to be capable of pivoting, such as in the direction of arrow “O”, and about a stationary point. An outermost edge of a front end portion 74′ of the counter-cam head can be greater distance from a pivot axis of the counter-cam 34′ than an outermost edge of the side portion 74″ of the counter-cam head 74″, as can be seen in FIGS. 4a & 4b. Also, in some embodiments, an outer edge profile of the counter-cam head 74 can have greater curvature rate at a front end portion 74′ thereof, and smaller curvature rate at side portions 74″ thereof. Also, In addition, the brake pads 40a and/or 40b can be slidably retained on retaining members 76, such as pins, as will be appreciated by those skilled in the art after reviewing this disclosure. In some embodiments, both brake pads 40a, 40b are slidable along pins 76, with each brake pad thus being capable of being moved by the counter-cam 74 head or cam-head 58. Thus, in the embodiments of FIG. 4a and 4b, when force is applied to the break discs 42a by cam head 58 (which can be actuated by a user applying breaks to drive cam-link 44′), counter-cam head 74 can be rotated or pivoted from the position in FIG. 4a, to the position in FIG. 4b, to release or decrease pressure on the brake discs 42a. That is, for example, as the front end portion 74′ of the counter-cam head 74 turns away to reveal a side portion 74″ of the counter-cam head to the brake pad 40a, the brake pad 40a is able to slide outward in the direction of arrows “P,” as the exposed edge of the side portion 74″ is closer to the pivot axis of the counter-cam 34′ than the outermost edge of the front end portion 74′. Counter-cam head 74 can be actuated to turn or pivot by being linked to an interlocking lever 54. The interlocking lever 54 can be interlocked with a steering lever (not shown in FIGS. 4a & 4b), such as by a linking member or rod, so that turning the front wheels 18 pivots the interlocking lever 54, which in turn, pulls or pushes counter-link 67′ to turn counter-cam head 74. This can release or decrease braking power applied. Breaking power applied can be reestablished or increased by turning the front end portion 74′ of the counter cam-head 74 back to face the brake pad 40a.

In various embodiments of the present invention disclosed, braking power or pressure applied to the brake discs 42a can be a function of turn angle of the front wheels 18, since this can affect travel distance of the counter-link 67, 67′, as will be appreciated by those skilled in the art after reviewing this disclosure. Also, in some embodiments of the present invention, an interlocking member 54 is not required, and a counter-link 67, 67′ can be coupled directly to the steering lever 56, to drive the counter-link 67 or 67′, as will be appreciated by those skilled in the art after reviewing this disclosure.

Although specific embodiments and examples of the invention have been described supra for illustrative purposes, various equivalent modifications can be made without departing from the spirit and scope of the invention, as will be recognized by those skilled in the relevant art after reviewing the present disclosure. The various embodiments described can be combined to provide further embodiments. The described devices, systems and methods can omit some elements or acts, can add other elements or acts, or can combine the elements or execute the acts in a different order than that illustrated, to achieve various advantages of the invention. These and other changes can be made to the invention in light of the above detailed description.

In general, in the following claims, the terms used should not be construed to limit the invention to the specific embodiments disclosed in the specification. Accordingly, the invention is not limited by the disclosure, but instead its scope is determined entirely by the following claims.

What is claimed is:

1. A remote control vehicle comprising:
a body;
at least one front wheel;
at least one rear wheel;
a brake system;
a steering servo and steering member connected to the steering servo, said steering member being capable of being moved by actuating the steering servo; and
a link member, linking the steering member with an interlocking member, said interlocking member being configured to respond to changes in position of the steering member to decrease braking power applied through at least a portion of the brake system when said front wheel is turned.

2. The remote control vehicle of claim 1 wherein decreasing the braking power applied is a function of an angle with which at least one of the wheels are turned.

3. The remote control vehicle of claim 1 wherein decreasing the braking power is a function of an angle with which the at least one front wheel is turned.

4. The remote control vehicle of claim 1 wherein the interlocking member is a pivotable member and further comprising a counter-link member usable to translate motion of the interlocking member to displace an orientation of a break cam.

5. The remote control vehicle of claim 4 wherein the break cam is further linked to a pivotable brake lever, the brake lever being coupled to a brake servo.

6. The remote control vehicle of claim 1 wherein the brake system comprises at least one front wheel brake disc and at least one front wheel brake pad and wherein said interlocking member is pivotably movable and wherein the interlocking member is coupled to the steering member such that the interlocking member pivots as a result of movement of the steering member, and further comprising at least a counter-link member to link the interlocking member to a break cam to decrease a pressure on the front wheel brake disc when the interlocking member pivots.

7. The remote control vehicle of claim 1 further comprising:
a counter-link member coupled to the interlocking member, wherein the interlocking member is pivotable about a fixed axis; and
a cam-link coupled to both the counter-link member and to another link member at opposite end portions of the cam-link, and wherein the cam-link is further connected to a brake cam, and wherein when the at least one front wheel is turned, the interlocking member pivots to displace the counter-link member.

8. The remote control vehicle of claim 1 wherein the brake system comprises at least two brake pads, each of the brake pads being proximate a different contacting surface, with a first surface being usable to apply pressure to the brake pads when a user actuates a brake servo of the remote control vehicle, and with a second contacting surface being usable to release pressure from the brake pads and to reestablish pressure on the brake pads as a function of a user actuating the steering servo to turn the remote control vehicle.

9. The remote control vehicle of claim 8 wherein each of the first and second contacting surface are surface on cam heads, and wherein applying or reducing pressure to the brake pads requires rotating the cam heads.

10. The remote control vehicle of claim 8 wherein the second contacting surface is a surface on a pivotable cam-head that can be pivoted to increase or decrease a distance between an outer edge portion of the cam head that contacts one of said brake pads and a pivot axis of the pivotable cam-head.

12. The remote control vehicle of claim 1 wherein the steering member and interlocking member are a single lever, and wherein the lever is both pivotable to drive a steering shaft for turning at least one of said wheels, and wherein the lever is coupled to said brake system to decrease braking power when the at least one of said wheels is turned.

13. A brake system for a remote control vehicle comprising:
a brake cam;
a cam-link connected to the brake cam for moving the brake cam to apply pressure to a brake pad; and
a counter-link coupled to a steering member through an interlocking member or directly to the steering member, wherein when the counter-link is moved, pressure on the brake pad can be decreased.

14. The brake system of claim 13 wherein moving the counter-link causes an opposing torque applied to the brake cam to decrease pressure on the brake pad that is applied through the cam-link.

15. The brake system of claim 13 wherein the counter-link is coupled to a second cam different from the brake cam, and wherein the second cam can be moved to decrease pressure on the brake pad and to re-establish pressure on the brake pad depending on the position of the second cam.

16. The brake system of claim 15 wherein the second cam has an outer edge profile with at least one point on the outer edge having a different distance from a pivot axis of the second cam than at least a second point on the outer edge of the second cam.

17. The brake system of claim 15 wherein the second cam has an outer edge profile with different curvature rates along different points on the outer edge profile.

18. The brake system of claim 13 wherein the counter-link is also coupled to the cam-link at an end portion of the cam-link and wherein an opposite end portion of the cam link is connected to a lever link that links a brake servo to the cam link for driving the cam link when a user selects to apply braking power.

19. The brake system of claim 13 wherein the counter-link is directly coupled to a steering member that is a pivotable lever.

20. The brake system of claim 13 wherein the counter-link is coupled to an interlocking member that is linked to the steering member.

21. The brake system of claim 20 wherein the interlocking member is a pivotable lever that can be pivoted as a result of movement of the steering member.

22. A method of controlling brakes in a remote control vehicle, the method comprising:
decreasing a pressure on at least a first brake pad as a function of turning angle of at least one front wheel of the remote control vehicle.

23. The method of claim 22 wherein the pressure is further decreased as an angle of wheel turn increases.

24. The method of claim 22 wherein decreasing said pressure comprises applying an opposing torque on a brake cam of the remote control vehicle, the opposing torque being applied via a counter-link member that applies force on a cam-link member linked to the brake cam.

25. The method of claim 24 wherein the cam-link member is linked to both a brake servo and a steering servo.

26. The method of claim 25 wherein when the brake servo is actuated to apply brakes, the cam-link is moved in manner that drives a contact face of the brake cam toward said at least a first brake pad, and wherein the cam-link can be moved in a manner to relieve the contact face from the at least a first brake pad when the steering servo is actuated.

27. The method of claim 22 wherein decreasing said pressure comprises releasing pressure from at least one of said at least a first brake pad and an opposite brake pad, wherein pressure can be applied to one of said brake pads by a first contact face, and wherein pressure can be released by moving a second contact face.

28. The method of claim 22 wherein decreasing the pressure further comprises rotating a counter-cam.

29. The method of claim 22 wherein decreasing the brake pressure comprises utilizing motion driven by a steering servo to rotate a counter-cam proximate an opposite brake pad, and wherein the opposite brake pad is slidable along at least one retaining pin.

30. The method of claim 29 wherein the counter-cam has a first edge portion that is further in distance from a pivot axis than a second edge portion of the counter-cam, and wherein rotating the counter cam can cause the first edge portion that is in contact with the opposite brake pad to move away from the opposite brake pad and cause the second edge portion of the counter-cam to come into contact with the opposite brake pad.

31. A brake system assembly for use on a remote control toy vehicle comprising:
a counter-cam having a counter-cam head wherein an edge of a front end portion of the counter-cam head is configured to be further in distance from a pivot axis of the counter-cam than an edge of another portion of the counter-cam head, and wherein both the edge of the front end portion and the edge of the another portion have contact faces for contacting a brake pad of the remote control toy vehicle; and
a counter-link member for use in interlocking the counter-cam to a steering member of the remote control vehicle.

32. The brake system assembly of claim 31 further comprising a lever configured to be pivotably mounted within a brake system of the remote control toy vehicle, and to be coupled to the counter-link member for interlocking the counter-cam to the steering member.

33. The brake system assembly of claim 31 further comprising:
a lever configured to be coupled to the counter-link member; and
an interlocking link member for linking the lever to a steering lever of the remote control toy vehicle.
